(19) United States
(12) Patent Application Publication
(10) Pub. No.: US 2020/0216166 A1
(43) Pub. Date: Jul. 9, 2020

(54) Terminal Approach Angle Guidance for Unpowered Vehicles

(71) Applicant: The Charles Stark Draper Laboratory, Inc., Cambridge, MA (US)

(72) Inventors: Russell E. Sargent, Arlington, MA (US); Brett J. Streetman, Waltham, MA (US); Laurent Duchesne, Brookline, MA (US)

(21) Appl. No.: 16/242,421

(22) Filed: Jan. 8, 2019

(51) Int. Cl. B64C 13/16; B64D 7/00; F42B 10/64; F42B 10/02

(52) U.S. Cl. CPC B64C 13/16; F42B 10/02; F42B 10/64; B64D 7/00

(57) ABSTRACT

A ballistic descent vehicle comprises an airframe, one or more control surfaces for controlling a descent of the vehicle, a controller, and a sensor suite to estimate both relative position, velocity, and flight path angle. Such a controller guides the vehicle, via the control surfaces, based on the estimated vehicle states, and a preprogrammed equivalent airspeed versus flight path angle two dimensional surface. During flight, the controller periodically consults the pre-computed equivalent airspeed versus flight path angle surface to obtain a desired flight path angle such that the vehicle asymptotically approaches a desired terminal approach angle while successfully navigating to the target. The use of this preprogrammed surface allows for the control of such vehicles with significantly lower computational resources, smaller control surfaces, and/or without relative airflow sensors onboard.

### GOVERNMENT SUPPORT

This invention was made with Government support under contract number Leidos HDTRA1-14-C-0019; Subcontract P010166674, awarded by the U.S. Department of Defense. The Government has certain rights in the invention.

### BACKGROUND OF THE INVENTION

The term “ballistic descent vehicles” generally refers to vehicles that glide through the atmosphere. They can be dropped from a plane, or released from a slow moving aerial platform such as a drone. In some cases, they are launched from rockets or fired as projectiles.

A number of applications, both military and commercial, require guidance of ballistic descent vehicles such that the vehicles reach desired targets with a desired terminal approach angle. In this application, the terminal approach angle is defined as the vehicle flight path angle prior to impact or landing. The vehicle could be a munition. On the other hand, there are other military, governmental, and commercial applications that could use such vehicles to deliver sensors, autonomous machines, and/or packages.

For such a vehicle to guide itself to the target, it needs to manage the conversion of its initially high potential energy, in the form of its altitude, into kinetic energy, such that the vehicle reaches the target with the desired terminal approach angle. Knowing the shape of its airframe allows such factors as lift and drag as function of velocity and altitude to be simulated. Additional variables include initial range to target and the altitude at which it begins its descent.

Currently, such ballistic vehicles are typically guided using powered flight guidance laws, such as the proportional navigation originally developed for homing missiles. One other current method for guiding such vehicles without adding additional control surface and/or without attaching air relative sensors is termed iterative predictor-corrector. At frequent periodic intervals in flight, an onboard flight control computer predicts the current vehicle trajectory with a given time-based sequence of bank commands. This prediction is performed onboard by numerically propagating the vehicle's state, using vehicle aerodynamic properties and the commanded bank angle, until the vehicle reaches the ground. Given the resulting predicted errors at impact (both the position and the approach angle errors), the sequence of commands is modified (i.e. corrected) and then re-propagated to the ground. This iterative method repeats until the resulting terminal predicted state error is below a tolerance. At that point these new bank commands are sent to the vehicle's controller. After a short fixed amount of time has passed (and long before the command sequence has been completed by the controller), the vehicle may have been perturbed from the desired trajectory. Therefore, the flight software re-executes the predictor-corrector iterations in order to generate an updated sequence of commands based on the latest current navigation state estimates. This repeats until the vehicle impacts or lands.

### SUMMARY OF THE INVENTION

Guidance laws have been shown to successfully reach the target. However, since such methods assume powered flight, the algorithms struggle to also achieve the desired flight path angle at impact. This is primary because the proportional navigation and other missile guidance laws do not explicitly consider how energy is lost in unpowered flight. Instead the proportional navigation assumes that the vehicle is on a collision course when the direction of its line-of-sight vector does not change. This is more or less valid for a powered flight missile, but is much less valid for unpowered projectiles, which fly arc-like trajectories due to drag and gravity effects. Therefore, in order to adapt these guidance methods to unpowered flight, many proposed vehicles use relatively large control surfaces and/or additional air relative sensors. Together or separately these additional actuators and/or sensors permit the vehicle to relatively quickly change the vehicle's approach angle prior to impact. In this way the vehicle can use existing methods to travel to the target and still achieve the desired terminal flight path angle at the end of flight. This solution, however, increases the cost and size of the vehicle,

Another problem with the current guidance approaches is that they are relatively computationally intensive and/or add additional size, mass, complexity, and/or cost requirements on the vehicle. As a result, the proposed vehicles tend to be relatively large and/or require relatively powerful onboard flight control computers or the vehicles must relay sensor data to a ground station or airplane, which can perform the computations required and then relay control instructions to the vehicles. Larger vehicles sized/mass limit their applications (i.e. cannot be fired as mutation or a given rocket or a given airplay payload). Additional costs of adding sensors and larger actuators increase per unit cost of vehicle.

In contrast, the present invention allows for the guidance and control of such vehicles with much lower computational resources while reducing size, mass, complexity, and/or cost. It relies on pre-computing a two-dimensional surface equation that provides the desired distance at which the vehicle should start traveling downwards to the target. This two-dimensional surface can be a function of only the current equivalent airspeed and current flight path angle. This distance at which the vehicle begins traveling downward, henceforth called the “pull down distance,” is calculated such that the vehicle retains the energy to successfully reach the target while asymptotically approaching the desired terminal approach angle. Since the vehicle no longer requires relatively quick changes to the vehicle's approach angle just prior to impact, larger control surfaces and additional relative sensors may not be necessary.

A key aspect is that the pull down distance is determined during flight and is not fixed for a given release point standoff distance. Real-time winds, aerodynamic uncertainty, and other variables cause the vehicle's trajectory to be perturbed from the ideal. Here, the guidance adapts by the flight control computer iteratively recalculating the pull down distance based on current navigation estimates to account for these perturbations.

As result, an onboard vehicle controller can then guide the vehicle with sensor information concerning the vehicle's target-relative position and velocity. This yields a robust guidance and control system that requires low computational resources to execute. As a result, the invention can enable simpler, less expensive, yet robust vehicles, such as sensor delivery systems, which can reach a target with a desired impact or terminal approach angle.

In general, according to one aspect, the invention features a ballistic descent vehicle comprising an airframe, one or more control surfaces for controlling a descent of the vehicle, one or more sensors that estimate the distance to the target (e.g., horizontal distance) and velocity (e.g., an equivalent airspeed), and a controller for controlling the vehicle via the control surfaces based on the distance to the target and the velocity.

According to the current embodiment, a pull down distance is determined during flight and is not fixed for a given release point standoff distance. Specifically, the controller accesses a preprogrammed velocity versus flight path angle surface to determine a pull down distance.

The distance can be based on a position sensor, such a GPS receiver chipset.

However, the one or more sensors can be included, such as an inertial measurement unit.

In different examples, a payload of the vehicle includes one or more sensors and/or explosives and/or packages.

In general, according to another aspect, the invention features a method for controlling a ballistic descent vehicle. The method comprises determining a distance to a target and velocity and controlling control surfaces of the vehicle based on the distance to the target and velocity and a preprogrammed speed versus flight path angle surface,

Preferably, the controller accesses the preprogrammed velocity versus flight path angle surface to determine a pull down distance. Prior to executing pulldown, the vehicle is controlled by bank to steer guidance law. Then, after executing pulldown, the vehicle is controlled by powered flight guidance law.

In general, according to another aspect, the invention features a method for controlling an aerial vehicle. The method comprises executing a bank to steer guidance law while determining a distance to a target. Then, after executing a pull down maneuver based on the distance to the target, the vehicle is guided to the target.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view of an exemplary vehicle to which the present invention could be applied;

FIG. 2 is a plot of altitude versus distance (horizontal range) to a target showing different vehicle trajectories;

FIG. 3A is a block diagram showing the control architecture for the vehicle;

FIG. 3B is a flow diagram showing the control method executed by the controller of the vehicle;

FIG. 4 is a plot of pull down distances in meters as a function of both flight path angle in degrees and equivalent airspeed in meters per second showing an exemplary speed versus flight path angle surface that is employed by the vehicle controller; and

FIGS. 5 and 6 are plots of altitude versus horizontal range showing different simulated trajectories each with a varied vehicle, environment, and sensor parameters, initial states, and aerodynamics.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For example, the terms equivalent airspeed and flight path angle are used. The commonly understood meaning of equivalent airspeed is the vehicle airspeed at sea level, under standard atmospheric conditions, that would produce the same dynamic pressure that is produced at the true airspeed and the altitude at which the vehicle is currently flying. In other words, equivalent airspeed is the vehicle's speed that would be required to create the same dynamic pressure at standard sea level air density. The commonly understood meaning of flight path angle is the angle between the local horizontal and the vehicle's velocity vector, with positive flight path angles traveling upwards; for example, a vehicle traveling directly downwards has a negative ninety degree flight path angle.

The commonly understood meaning of Zero Effort Miss-distance (ZEM) is miss distance that would result if the vehicle did not maneuver for the remainder of the flight with all environmental distances held constant. If at any point in the flight the vehicle has a ZEM value of zero, it means the vehicle will reach the desired target without additional maneuvers (e.g. by maintain the current bank angle) assuming the winds are constant.

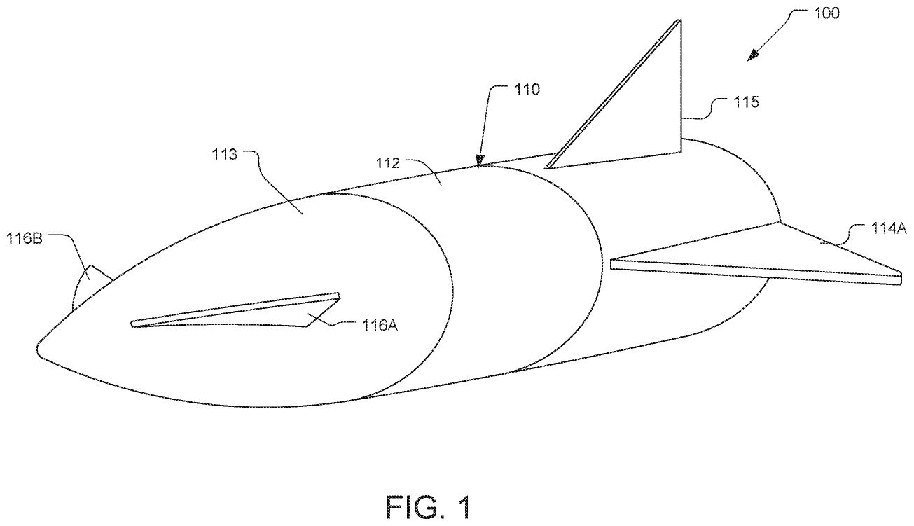

FIG. 1 shows one possible example of a ballistic descent vehicle 100 to which the present invention might be applied.

The vehicle 100 includes an airframe 110. The airframe 110 has a tubular body 112, which has an oval cross-section, in the illustrated example. The body 112 ends in a conical nose cone 113.

According to one possible use for the vehicle, the nose cone 113 might be harden. This allows the vehicle to embed itself in the ground after approaching its target at a vertical terminal approach angle.

The illustrated embodiment includes two small aft wings 114. Note only one wing 114A is shown. The other wing 114B is hidden by the body 112 in the figure. A tail fin 115 is preferably added for stability.

The vehicle has two canards 116A, 116B located on the nose cone 113. Each canard may translate and/or pivot and/or extend to function as a flight control surface of the vehicle 100.

The illustrated vehicle 100 uses its gliding airframe to cover the range to the target. Such vehicles are stabilized aerodynamically by the use of the tail fin 115. The two canards are provided for guidance during its glide phase to employ bank to steer controlled

In a typical use case, the vehicle is dropped from a plane. Initially the vehicle 100 executes a glide phase. In this flight phase, the canards 116 and other controller surfaces, e.g. tail 115, are deployed, if previously folded. The combination of lift on the canards 116 and wings 114 and asymmetric drag on the wings 114 and tail fin 115 will tend to cause the vehicle to adopt an attitude with a small positive angle of attack to the airstream which will provide lift.

From this condition, the canards 116 can be controlled differentially to bank the vehicle to turn, for example, and to execute a precision impact, in response to an onboard navigation system and controller 210.

In one embodiment, the vehicle employs bank to steer (or turn) guidance. A vehicle using bank to turn guidance requires that vehicle's center of gravity is offset from the center of pressure. During flight this offset creates a steady state (or trim) non-zero angle of attack. This angle of attack generates a lift vector perpendicular to the air relative direction of motion. Bank to steer guidance rotates (or banks) the vehicle with respect to the air relative velocity vector. In this way, the vehicle can accelerate in different directions (i.e. the locus of directions perpendicular to the air relative velocity vector) with limited control authority. For example, if the vehicle is banked such that the lift vector points in the direction furthest from the ground (e.g. ‘banks up’), a significant component of the lift vector will oppose the gravity force on the vehicle, thereby decreasing its downward acceleration. Alternatively, if the vehicle is banked such that the lift vector points in the direction closest to ground (e.g. ‘banks down’), a significant component of the lift vector will be aligned with the gravity force on the vehicle, thereby increasing its downward acceleration. Note in bank to steer guidance the vehicle may not have the control authority to alter the vehicle's angle of attack from trim. As a result in such vehicles, the control is significantly constrained and may only achieve a given acceleration direction, not an acceleration magnitude. The yaw dynamics are preferably passively stable (yaw oscillation will damp out without active control). In general, the vehicle may be actively or passively controlled to directly damp yaw moments.

The differential operation of the canards 116 to bank the vehicle 100 may be affected by changing their respective incidence angles, as in the case of conventional canards.

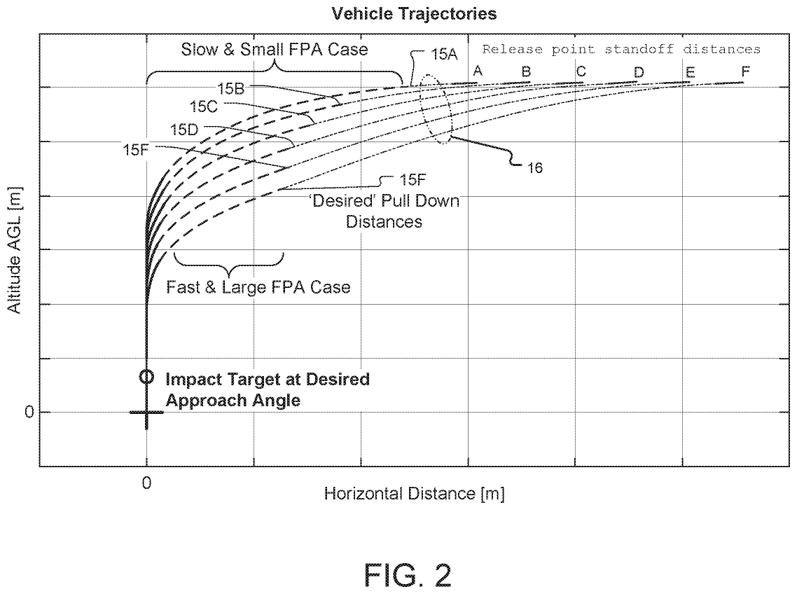

FIG. 2 is a plot of altitude as a function of distance or range to the target. It shows different flight paths based on release point standoff distances that will bring the vehicle to the target with a vertical terminal approach angle. In this example, the desired terminal approach angle is negative ninety degrees to the horizontal, and generally −90 degrees +/−10 degrees. Other terminal angles are possible by changing the values of the two-dimensional surface, as explained below, such as between −90 and −70 degrees or between −45 and −60 degrees.

The vertical terminal approach angle is consistent with a number of different use cases for the vehicle. The vehicle, of course, could be used as a munition, where the terminal angle enables the munition to avoid nearby obstacles. Such obstacles include nearby buildings, hills, personnel, etc. Additionally, the vertical approach angle would yield a high kinetic energy for munitions such as bunker busters. In this application a given terminal angle is necessary for the bunker buster ordinance to reach its subterranean target. Outside of military uses, the vehicle could be used to deliver sensor packages. Thus, a single vehicle or squadron of the vehicles could be used to deploy a multitude of ground sensor packages from an airplane or other aerial platform. In such an application, each vehicle with its sensor package could target a unique location such that the vehicles autonomously and collectively arrange themselves in a sensor array. For example, an array of sniffer sensor packages could be deployed to remote locations to detect gas leaks from natural gas pipelines. In other cases, the vehicles could contain sensor packages, each with an array of sensors, such as magnetometers, seismometers, and/or gravimeters, to detect oil reserves below ground in remote locations.

This vehicle could be also used as a delivery platform to distribute packages. In this application the vehicle could deliver a package with a predetermined terminal angle to avoid obstacles. The vehicle preferably further includes a parachute (or other drag device) that is deployed above the target and/or reverse thrusters to prevent the vehicle with its package from rolling at ground impact and/or undergoing damaging deceleration.

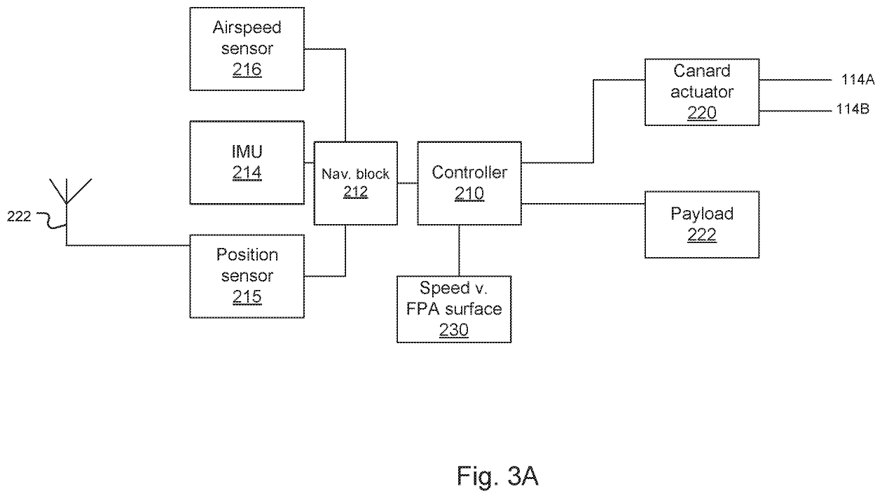

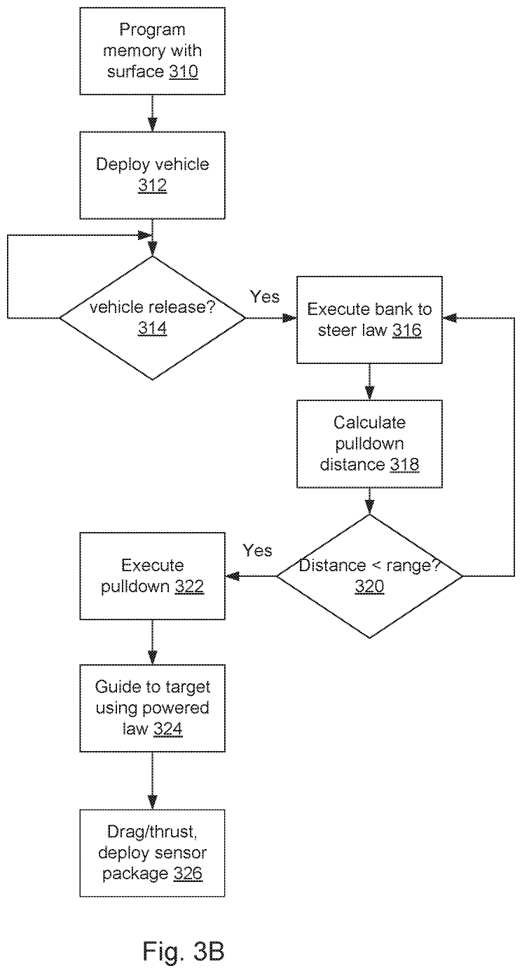

FIG. 3A shows the control architecture for the vehicle. A vehicle controller 210 is responsible for the operation of the vehicle 100 and most importantly flight control. In general, it receives information from the vehicle sensors and then controls the canards 114 in order to guide the vehicle to the target. The vehicle has a designed flight envelope. This is the range of combinations of speed, altitude, angle of attack, etc., within which the vehicle is aerodynamically stable. The controller generally controls the vehicle to stay within that envelope.

A position sensor 215 is also provided. This is used to detect the distance to the target. In the most common implementation, the position sensor is a satellite navigation (GPS, e.g.) receiver chipset and associated antenna 222 for satellite-based radio-navigation system. Minimally, the position sensor 215 is used to determine the vehicle's target-relative location (longitude, latitude, and altitude/elevation). With this information, the controller 210 determines the range to the preprogrammed target.

In some embodiments, the position sensor may also or alternatively directly measure relative distances using a range sensor, such as a camera, Lidar Range finder, laser designator, RADAR, etc. Another option is a local positioning system that is complementary to GPS. The local positioning might use cellular and broadcast towers or other beacons to derive the vehicle's position.

An airspeed sensor 216 can be added to the vehicle to directly detect the equivalent airspeed of the vehicle 100. Commonly, this might be a Pitot tube, Pitot probe, or even an air data boom. These devices are widely used to direct airspeed and air flow direction on an aircraft. They generally consist of a tube that points directly into the airflow to measure the stagnation pressure. Alternatively, the equivalent airspeed and direction can be approximated by navigation using the current estimate of the ground relative velocity and current air density.

Nevertheless, a key advance of the present system is that such airspeed sensors are not required or even necessary. It is robust to wind uncertainties and therefore may only require ground relative (not air relative) measurements.

In the most common implementation, the ground speed sensing is fulfilled by the position sensor 215, e.g., the satellite navigation (GPS, e.g.) receiver chipset. In the most common implementation, the air density can be estimated using the current altitude (via position sensor) and simple standard atmosphere model equations, such as US 1976 standard atmosphere equations.

In order to reduce system-cost, different position sensors could be used. For example, in the illustrated embodiment, an inertial measurement unit (IMU) 214 is also provided in some implementations. Generally, the IMU reports a vehicle's specific force, angular rate, and sometimes the magnetic field using a combination of accelerometers and gyroscopes, sometimes also magnetometers. Then, if the location of the drop point is known or the relationship between the drop point and target, the IMU detects the vehicle's movement from that drop point. In the most common implementation, a commercially available GPS/INS system, which provides ground relative position, velocity, and flight path angle.

An airspeed sensor 216, the IMU 214 and the position sensor 215 report to a navigation block 212. This module generates an estimate of the navigation state of the vehicle 100 from the GPS/IMU and airspeed sensor 216. This block estimates flight path angle and equivalent airspeed (if no airspeed sensor is attached).

The controller 210 uses the information from the sensors 215, 216 and the IUM 214 to understand both the vehicle's location and velocity relative to the target and the vehicle's movement relative to its flight envelope based on the processing of the navigation block 212.

The controller 210 then controls the canard actuator 222 to keep the vehicle 100 within a defined flight envelope.

The controller 210 also guides the vehicle to the target with reference to a speed versus flight path angle surface that has been stored into memory 230, such as read only (ROM) memory.

Once embedded at the target, the controller 210 can further control the payload 222. This payload could be a package or explosive. Another option is a sensor package containing different sensors. Those sensors might be deployed to detect the existence of a natural gas leak, for example. In other cases, the payload 222 includes a sensor package, each with an array of sensors, such as magnetometers, seismometers, and/or gravimeters, to detect oil reserves below ground in remote locations. When used as a delivery platform, the payload is a package.

Additionally, note that a slave inner loop controller is required to directly command the canards. Typically including a proportional, derivative, and integral (PID) controller, the inner loop controller damps out excessive pitch rate and/or achieves the desired roll rates needed to attain the commanded bank angle. The yaw dynamics are preferably passively stable (yaw oscillation will damp out without active control). In general, the vehicle may be actively or passively controlled to directly damp yaw moments.

FIG. 3B shows a method of operation of the vehicle and specifically its controller 210,

Prior to the vehicle's mission, the speed versus FPA surface is calculated for its desired mission parameters and programmed into the memory 230 of the controller 210 in step 310.

Then the vehicle is deployed in step 312.

The controller waits for a signal or otherwise determines whether the vehicle has been released from an airplane/drone or separated from a booster or has reached the apex of a mutation trajectory such as by monitoring its sensors, in step 314.

Upon determining release, the controller 210 executes the first phase of its flight, see reference 16 of FIG. 2. Specifically, in step 316, controller 210 controls the canards 116 and preferably employs bank to steer guidance laws to remain within the flight envelope and limit the vehicle's decent rate while removing lateral position errors. This guidance strategy permits the vehicle 100 to limit altitude loss while altering its bearing to travel in the horizontal direction of the target. During this first flight phase the vehicle's controller 210 must also decide when to start traveling downward to the target in a way that the nominal vehicle asymptotically approaches the desired terminal approach angle. This distance at which the vehicle should begin traveling downward or “pull down,” is henceforth call the “pull down distance.”

Periodically throughout this first flight phase 16 (i.e. at each short time step), the controller 210 continuously recalculates the desired pull down distance using the pre-computed two-dimensional surface stored in memory 230, the current estimate of the equivalent airspeed, and the current estimate of the flight path angle in step 318. If the most recently calculated pull down distance is greater than to the current horizontal range to the target in step 320, the controller 210 should continue executing the first flight phase to reduce lateral errors and limit vertical descent according to step 316. If, however, the most recently calculated pull down distance is less than or equal to the current horizontal distance to the target, the controller 210 should begin executing the “pull down” maneuver in step 322.

During the pull down maneuver the controller 210 issues bank commands such that the vehicle aligns its lift vector closest to the local down direction (i.e. ‘banks down’). As a result, the vehicle increases its acceleration in the downward direction, thereby lowering its flight path angle.

As detailed below, the pull down pre-computed two-dimensional surface stored in the memory 230 is generated such that the nominal vehicle, under nominal conditions, will begin executing the pull down maneuver such that the vehicle achieves a ZEM value of zero when the vehicle achieves the desired terminal flight path angle. For example, if the desired flight path angle is −90 degrees, the pull down would occur such that the vehicle is directly over the target when the vehicle first achieves the −90 flight path angle. In actual flight, perturbations such as aerodynamic uncertainties, winds, navigation errors, etc. alter the vehicle state such that the ZEM value when the vehicle first achieves the desired flight path angle is relatively small, but not zero. In the example above, when vehicle first achieves −90 flight path angle at an altitude above the target, a perturbed vehicle may have some residual horizontal position error. To remove this position error, the vehicle can begin implementing a powered flight guidance law, such as proportional navigation, when the vehicle flight path angle is within a tolerance of the desired terminal flight path angle in step 324.

The use of powered flight guidance law is appropriate because at this stage of the flight the vehicle is on a trajectory with a) a small ZEM value, b) at or near the desired flight path angle, and c) traveling at or near the terminal velocity. Under these conditions the existing powered flight guidance laws, such as proportional navigation, are valid. In particular, the proportional navigation fundamental assumption (that the vehicle is on a collision course when the direction of its line-of-sight vector does not change) is valid when the ZEM value is close to zero and the vehicle is on a constant flight path angle (glides slope) with a constant velocity. Note that prior to the pull down maneuver, the vehicle did not meet the three criteria stated above.

Once both the pull down maneuver has been executed and the vehicle's flight path angle is within a tolerance of the desired terminal flight path angle, a powered guidance law, such as proportional navigation, can successfully steer to the target. This is done by trading small deviations from the desired flight path angle for reductions in the ZEM. In other words, once the vehicle has obtained both a small flight path angle error and a small ZEM value at the end of the pull down maneuver, the traditional powered flight guidance laws can achieve both the desired landing accuracy and meet the terminal flight path angle constraint without requiring excessive control authority (i.e. without requiring large changes in the vehicles fight path angle). In this way the controller implements a powered guidance law to steer to the target. In the case of proportional navigation, the controller will bank the vehicle's lift vector at a rate proportional to the rotation rate of the line of sight and in the same direction. This continues until the vehicle intercepts the ground or reaches a target altitude to deploy the drag devices or vertical thrust in step 326. Finally, the vehicle might deploy its sensors or package.

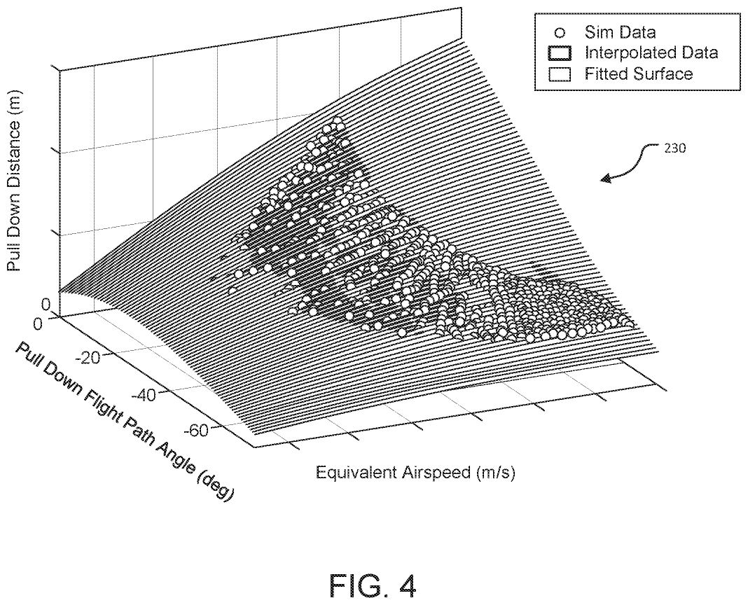

FIG. 4 is a plot showing a speed versus flight path angle surface that would have been simulated and then programmed into the memory 230 of the vehicle 100 prior to deployment. In general, the equivalent airspeed versus flight path angle surface 230 is a two-dimensional surface showing the one-to-one relationship between the desired pull down distance in meters vs. the current vehicle flight path angle in degrees and current vehicle equivalent airspeed in meters per second. This represents combinations of flight path angle and pull down speed that are within the vehicle's flight envelope. The pull down distances are a measure of the vehicle's current horizontal range from the target. With this information, at each time step the controller 210 is able to select the proper pull down distance 15A-15F that is required for any airspeed and flight path angle in the flight envelope, such that the vehicle will arrive at the target while asymmetrically approaching the desired approach angle.

The flight path angle, equivalent airspeed, pull down distance surface is generated prior to flight using a simple off-line simulation of the nominal vehicle dynamics. The release envelope defines acceptable states for the vehicle once it is released from an aerial platform (or the acceptable state at the apex of a munition's trajectories). These states are typically the down range distance and equivalent airspeeds, but may also include other dimensions such as initial release flight path angles. To calculate the pull down distance surface, first the release envelope is divided into discrete initial condition points, such that the points span the release envelope. For each initial condition point, a mission is simulated multiple times with the controller in the loop with the pull down horizontal distance systematically varied. For each simulation run, the vehicle flight is simulated through the pull down maneuver until the vehicle reaches the desired terminal flight path angle with a ZEM value of zero. In this case a ZEM value of zero means that the simulated vehicle is able to reach the target while generally maintaining the current flight path angle. For each initial condition point, the proper ZEM error can be used to proportionally correct the next pull down distance. This iteration repeats until the vehicle achieves the desired terminal approach angle while successfully navigating to the target (i.e. achieve a ZEM value of zero prior to embedment). The pull down distance is then recorded along with the flight path angle at pull down and equivalent airspeed at the pull down to generate simulation data. If the off-line simulation concludes no pull down solution exists, the initial condition point is outside the release envelope and should be avoided in flight. For example, the vehicle may be released with an initial altitude too low and/or an initial airspeed too slow such that the vehicle can reach the target or achieve the terminal flight path angle, but lacks the initial energy to achieve both goals. To remedy the problem, the vehicle release envelope must be amended such the vehicle releases at a higher altitude and/or a faster speed. Additionally, it is recommended that the release envelope and release altitudes are defined such that the nominal vehicle achieves both a ZEM value of zero and the desired flight path angle at altitudes above some tolerance. As described above, this permits the controller 210 time to implement powered guidance laws to ‘cleanup’ any state errors previously caused by environmental/vehicle perturbations as described above.

As shown in FIG. 4, all the recorded simulation data points will create a unique point in the flight path angle vs. equivalent airspeed vs. pull down distance space. These points are indicated by the circles (“Sim Data”). This data may further be used to generate interpolated data as indicated by the dark regions. Finally, altogether these points generate a 2-D single surface 230, unique to each vehicle, flight envelope, and desired terminal approach angle. These points can be used to generate a fitted surface equation using commercially available surface fits tools. The fitted surface equation is then loaded into the equivalent airspeed vs. flight path angle surface memory 230 that is accessed by the controller.

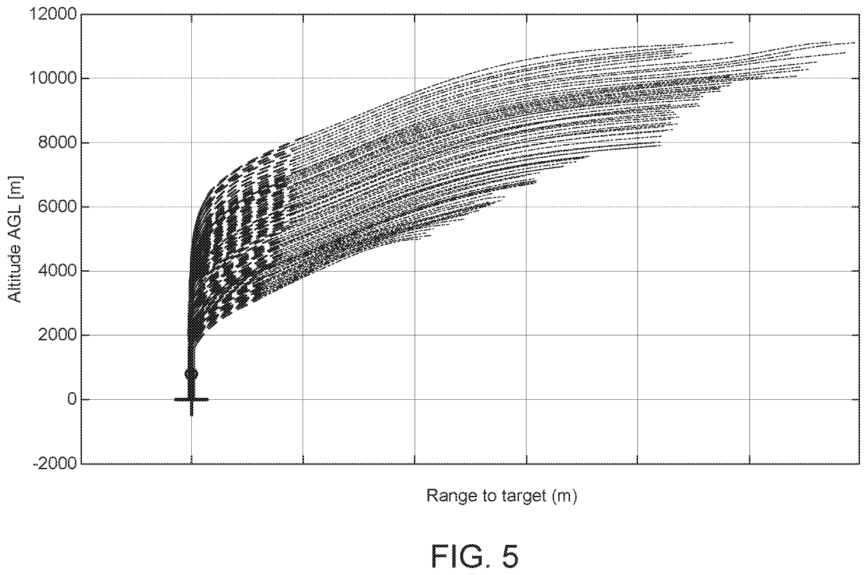

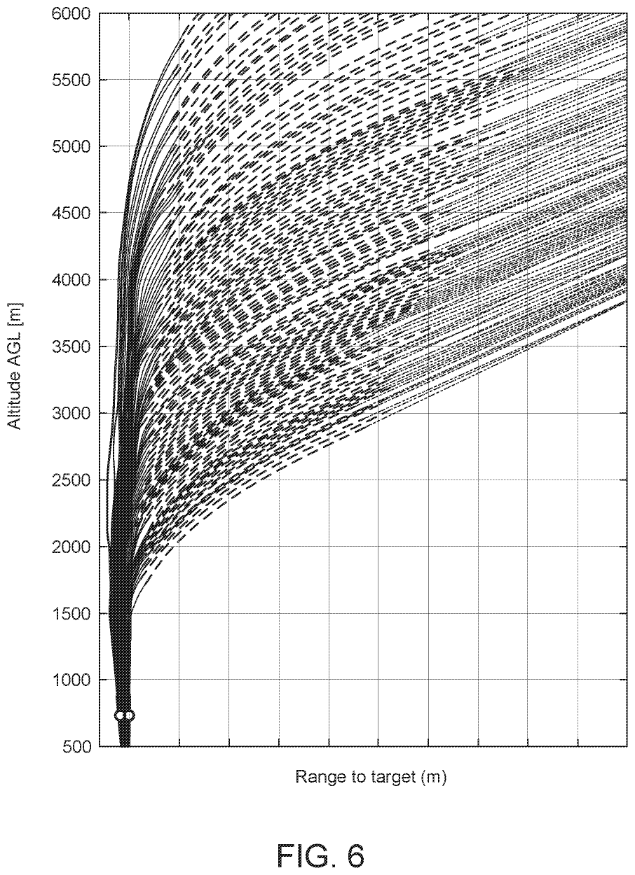

FIG. 5 is a plot of altitude versus range showing different simulated vehicle flight paths. FIG. 6 is a detailed view of the plot of FIG. 5. They represent a Monte Carlo analysis for different randomized release conditions, vehicle mass, vehicle aerodynamics, winds, air density, sensor accuracy, actuator uncertainties and delays. The plots show that despite these uncontrolled variables, the vehicle operated as described herein will successfully navigate to its target using the preprogrammed equivalent airspeed versus flight path angle surface.

While this invention has been particularly shown and described with references to preferred embodiments thereof, it will be understood by those skilled in the art that various changes in form and details may be made therein without departing from the scope of the invention encompassed by the appended claims.

What is claimed is:

1. A ballistic descent vehicle, comprising:
an airframe;
one or more control surfaces for controlling a descent of the vehicle;
one or more sensors that estimate the distance to the target and velocity; and
a controller for controlling the vehicle via the control surfaces based on the distance to the target and the velocity.

2. The vehicle of claim 1, wherein a pull down distance is determined during 1 and is not fixed for a given release point standoff distance.

3. The vehicle of claim 1, wherein the velocity is an equivalent airspeed.

4. The vehicle of claim 1, wherein the controller accesses a preprogrammed velocity versus flight path angle surface to determine a pull down distance.

5. The vehicle of claim 1, wherein the distance is based on a position sensor.

6. The vehicle of claim 5, wherein the position sensor is a GPS receiver chipset.

7. The vehicle of claim 1, wherein the one or more sensors includes an inertial measurement unit.

8. The vehicle f claim 1, wherein the distance to the target is the horizontal distance to the target.

9. The vehicle of claim 1, wherein a payload of the vehicle includes one or more sensors.

10. The vehicle of claim 1, wherein a payload of the vehicle includes explosives.

11. The vehicle of claim 1, wherein the one or more control surfaces include canards.

12. A method for controlling a ballistic descent vehicle, comprising:
determining a distance to a target and velocity; and
controlling control surfaces of the vehicle based on the distance to the target and velocity and a preprogrammed speed versus flight path angle surface.

13. The method of claim 12, further comprising determining a pull down distance during flight, which is not fixed for a given release point standoff distance.

14. The method of claim 12, wherein the velocity is an equivalent airspeed.

15. The method of claim 12, wherein the controller accesses the preprogrammed velocity versus flight path angle surface to determine a pull down distance.

16. The method of claim 15, wherein prior to executing pulldown, the vehicle is controlled by bank to steer guidance law.

17. The method of claim 15, wherein after executing pulldown, the vehicle is controlled by powered flight guidance law.

18. The method of claim 12, wherein the distance is based on a position sensor.

19. The method of claim 18, wherein the position sensor is a GPS receiver chipset.

20. The method of claim 12, wherein the one or more sensors includes an inertial measurement unit.

21. The method of claim 12, wherein the distance to the target is the horizontal distance to the target.

22. The method of claim 12, further comprising activating a sensor payload of the vehicle.

23. A method for controlling an aerial vehicle, comprising:
executing a bank to steer guidance law while determining a distance to a target;
executing a pull down maneuver based on the distance to the target; and
guiding the vehicle to the target after the pull down maneuver.
